(19) United States
(12) Patent Application Publication
(10) Pub. No.: US 2009/0323732 A1
(43) Pub. Date: Dec. 31, 2009

(54) Optical Wave Generator

(76) Inventor: Abdel Fetah Benabid, Bath (GB)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/376,249

(22) PCT Filed: Aug. 2, 2007
(86) PCT No.: PCT/GB2007/002936

§ 371 Date: May 28, 2009

(30) Foreign Application Priority Data
Aug. 4, 2006 (GB) 0615541.0

(51) Int. Cl. H01S 3/30

(52) U.S. Cl. 372/3

(57) ABSTRACT

An optical wave generator comprising a first-level Raman sideband generator (RSBG). The first-level RSBG comprises a first hollow-core photonic crystal fibre HCPCF (203) arranged to be filled with a Raman active gas and a first two-pump continuous wave (CW) laser source (200) having a first pump laser beam (201) at a first frequency and a second pump laser beam (202) at a second frequency, the laser source being arranged to excite the first HCPCF to generate a Raman sideband spectrum comprising a first plurality of spectral components.

The present invention relates to an optical wave generator.

A number of major developments have been achieved in the field of photonics. For example, coherent and relatively compact laser sources with wavelengths spanning from UV to IR are now commercially available and used in a number of applications as varied and various as telecommunications, high resolution spectroscopy, lithography and biomedicine. In telecommunications the information is carried by optical fibres and a great deal of signal processing is achieved using only light (for example wavelength division multiplexing (WDM)). The development of several laser based high precision measurements in spectroscopy has led to the advent of laser cooling, femto-chemistry and Bose-Einstein condensates. Photonic bandgap physics has also developed photonic crystal devices which hold the potential for taking the role in photonics of that of semiconductors and microchips in electronics.

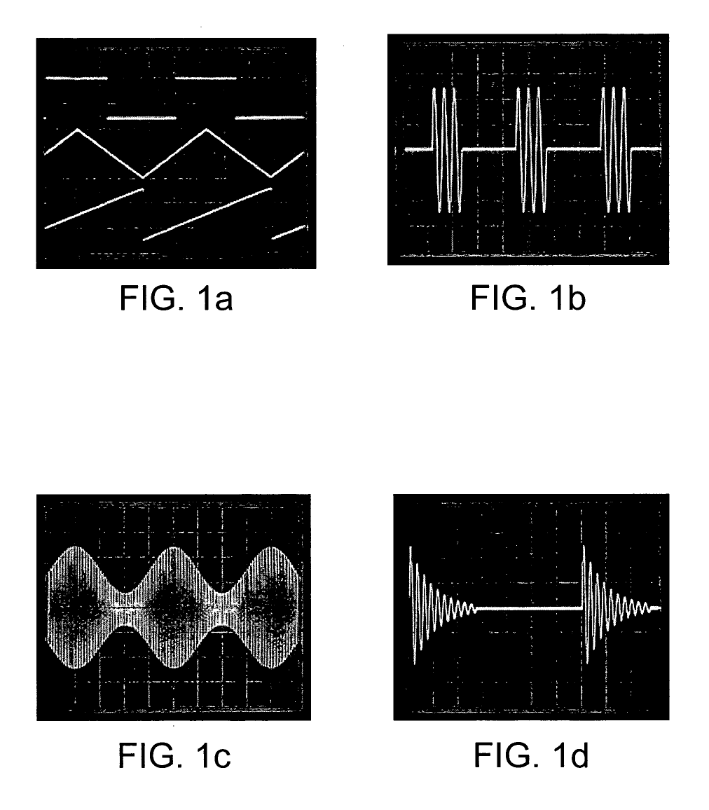

One goal in photonics is the ability to synthesize electronic waveforms. In the analogous field of electronics, it is possible to make, for example, sine, triangle and square waves as well as pulses, ramps and haversines (see FIG. 1 showing square, triangle and ramp waveforms in FIG. 1a, burst modulated waveforms in FIG. 1b, amplitude modulated waveforms in FIG. 1c and arbitrary waveforms in FIG. 1d). with a high degree of stability and accuracy over a frequency range spanning from ˜1 mHz to up to a few hundred GHz. This is based on Fourier synthesis which relies on the fact that the Fourier spectrum of a set of phase-locked spectral components is a linear combination of sine waves. This can be seen as an “algebra” of sine waves or equivalently of frequencies and it is this kind of algebra which made electronic signal and information control and manipulation possible.

There has been some development in generating, shaping and measurement of ultra-short optical pulses. This is achieved by either using high harmonic generation (HHG) or, as discussed in Harris and Sokolov, “Subfemtosecond compression of periodic laser pulses”, Opt. Lett. 24 (17), 1248-1250 (1999), by molecular modulation (Raman sideband generation). However, the impact of such achievements is limited as the waveform shaping is restricted to isolated short pulses (nanoseconds duration in the case of molecular modulation and femtoseconds in the case of HHG).

For example, for the case of Raman sideband generation, in order to have efficient generation of a broad spectrum, narrow-linewidth driving fields are needed (less than the Raman resonance linewidth) with a high enough intensity (several GW/cm²). These requirements have limited thus far the implementations of this scheme to extremely powerful transform-limited nanosecond pulsed lasers. Consequently, the synthesized waveform is circumscribed by waveforms of the isolated pump nanosecond pulses.

The present invention is set out in the claims. Because of the use of hollow-core fibres containing the Raman active gas, the effective interaction length is increased, as a result of which the input power requirements are reduced, allowing a CW laser source to be used. This means that the generator may act in the field of photonics in an analogous way to a function generator in electronics.

Examples of the present invention will now be described with reference to the accompanying drawings, in which:

FIG. 1a shows samples of square, triangle and ramp waveforms synthesized electronically;

FIG. 1b shows samples of burst modulated waveforms synthesized electronically;

FIG. 1c shows samples of amplitude modulated waveforms synthesized electronically;

FIG. 1d shows samples of arbitrary waveforms synthesized electronically;

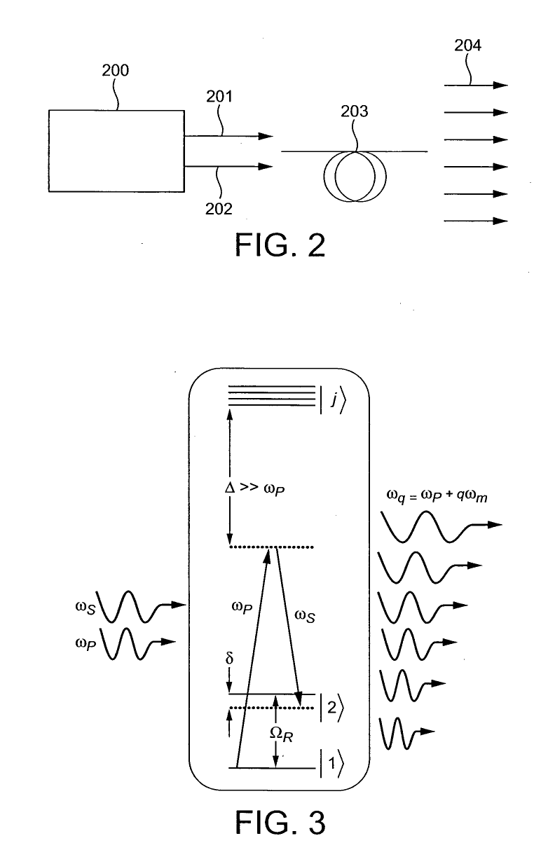

FIG. 2 is a schematic diagram of an example optical waveform generator with a first-level generating component;

FIG. 3 is a schematic energy-level diagram for establishing coherence in a medium and generating coherent sidebands;

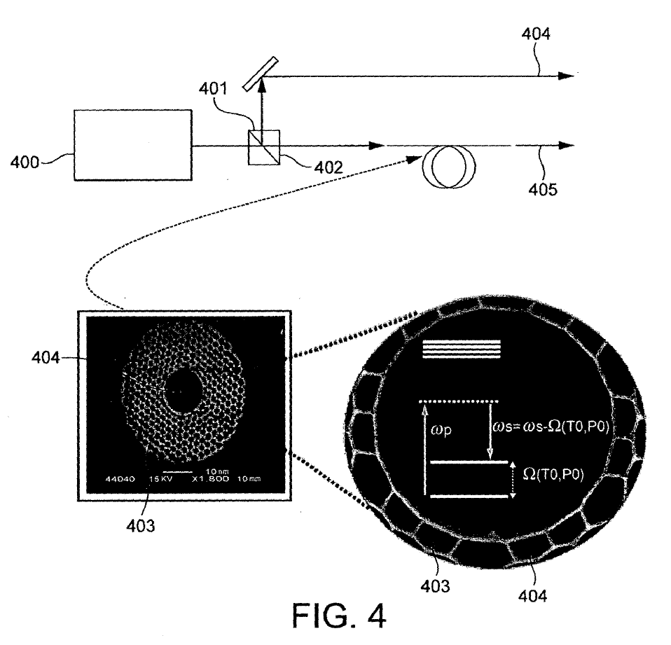

FIG. 4 is a schematic diagram of a two-pump laser source; and

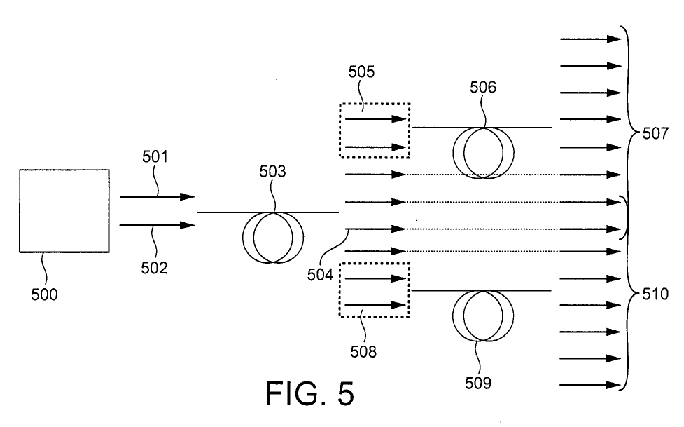

FIG. 5 is a schematic diagram of an example optical waveform generator with a first- and second-level generating component.

In overview, the optical waveform generator is based on a hollow-core photonic crystal fibre (HCPCF) filled with a Raman active gas. The generator operates in an analogous way to an electronic or RF waveform generator and covers wavelengths from IR to UV. It can generate and synthesize optical waveforms with a frequency range from ˜10 THz to a few 100 THz and with any central wavelength from UV to IR. The generated frequency could also be as small as a few 100 MHz. The frequency is determined by the choice of the Raman gas which could be molecular, for example H₂, D₂, SF₆, or in an atomic vapor state, for example, Rb, Cs, Ca, Na. The gas could be any Raman active gas with a resonant frequency which lies within the bandwidth of the HCPCF.

The generator may also be used as a coherent laser source covering ultraviolet, visible light and infrared simultaneously. The generator may also be used for ultra-short laser pulse generation (femtosecond and attosecond). The generator may be used as ultra-fast optical FM and AM modulator. The device could be used as an ultra-fast optical switcher. It could be used as a TeraHertz coherent radiation source. An all fibre version of the generator adds compactness and user-friendliness.

HCPCF is also known as band-gap fibre, air-guiding band-gap fibre, or microstructure fibre. The term HCPCF as used herein is understood to cover all such alternative terminologies, which will be familiar to the skilled reader. In HCPCF the hollow core is surrounded by a cladding of silica microcapillaries which creates a photonic band gap, trapping the light in the core. Physically, it is a fibre whose outer diameter is around 125-200 μm and whose core diameter usually ranges from 5 μm to 20 μm, although in principle there is no upper limit to the diameter. The thickness of the silica web of capillaries is only a few 100 nanometres (typically: 300 nm-500 nm).

The approach discussed herein recognizes that the generation process is proportional to the product of density and length on one hand and the maximal coherence implies minimizing the dephasing rate of the medium, which means keeping the pressure to a minimum, on the other hand. This means that to bring this scheme to a continuous wave regime it is necessary to increase the interaction length whilst keeping the driving laser beams well confined and with a good quality of transverse profiles for s efficient spatial overlap. However, because of the intrinsic diffractive nature of free space laser beams, most focused laser beams are limited, at best, to effective interaction lengths of a few centimetres (limited by the Rayleigh range). This fact has hampered all laser-gas-phase material nonlinear interactions.

An example according to the present invention is described below with reference to FIG. 2. This example enables the provision of a system which can generate optical waveforms, including to synthesize such waveforms. These may include attosecond pulses. The term optical is used to mean any form of electromagnetic radiation. The system is compact and may be an all-fibre system. The example combines three technical concepts: a molecular modulation technique, a hollow-core photonic crystal fibre and high-power and narrow-linewidth CW fibre lasers.

An example optical waveform generator comprises a first-level Raman sideband generator (RSBG) comprising a two-pump CW laser source 200 having a first pump laser beam 201 and a second pump laser beam 202. The component further comprises a first hollow-core photonic crystal fibre (HCPCF) 203 filled with a Raman active gas (e.g. H₂ or D₂). This HCPCF 203 is kept under controllable conditions of temperature (T₁) and pressure (P₁).

The two pumps 201, 202, which may originate from different lasers or both from the same laser, are arranged to act as driving fields to generate a Raman sideband spectrum 204 by exciting the Raman gas contained in the HCPCF 203. Generation of a Raman sideband spectrum is discussed below.

As discussed in Solokov and Harris, it is possible to generate a wide, phase-coherent spectral comb by adiabatically preparing a macroscopic molecular ensemble of a Raman medium in a single vibrational or rotational superposition-state. This means it is possible to control light waves using Fourier synthesis. This macroscopic molecular ensemble is achieved by driving the medium by two lasers 201, 202 at frequencies ωₚ and ωₛ whose beat frequency, ω_{P}−ω_{S}=Ω_{R}±δ, is slightly detuned from the Raman resonance frequency ω_{R}(T₀, P₀). This configuration ensures that the systems evolve in a superposition state with the maximum value possible for the coherence ρ₁₂. As a result, this strong coherence of the medium modulates each of the incident laser beams, resulting in a generation of Stokes and anti-Stokes (i.e. Raman sidebands) without the restriction of the phase matching. Equivalently, the coherent Raman medium acts as a phase modulator with a frequency modulation set by the Raman transition (˜18 THz for rotational transition in ortho-hydrogen or 125 THz for a vibrational transition in hydrogen) and spectrum width set by the detuning of the first electronic excited state from the driving fields. The bandwidth can be as wide as 2000 THz for hydrogen thus covering the ultraviolet/visible/infrared regions of the electromagnetic spectrum. Moreover, because the spectral components of the generated spectrum are mutually coherent (i.e. phase-locked), the temporal profile of the output light can be synthesized by only adjusting the magnitude and/or the relative phase of a chosen set of “teeth” of the generated spectral comb. FIG. 3 shows an energy-level diagram for establishing coherence in a medium and generating coherent sidebands. |1> and |2> are the states of the Raman transition. |j> are far detuned upper electronic states.

Detuning of the beat frequency between the driving fields, Ω(T₀,P₀), and the Raman resonance Ω(T₁,P₁) in the first HCPCF 203 is controlled by controlling the temperature T₁ and pressure P₁. Even if the temperature range is limited to cryogenic values and the pressure to less than 1 atm (for room temperature), the dynamic range of the detuning frequency is several 100 MHz which is enough to have a reasonable control in establishing strong coherence. Furthermore, this dynamic range can be extended by the use of commercially available frequency shifters (not shown). The generated coherent spectrum which is limited by the transmission bandwidth of the bandgap fibre (˜70 THz) may then be fed to optical delays (not shown) and other optical components for dispersion compensation and/or power attenuation in order to control the relative phase and magnitude of the spectral components. Finally, the spectrum is sent to a component (not shown) such an autocorrelator or a frequency resolved optical grating (FROG) for the waveform measurement and synthesis.

The use of a HCPCF 203 filled with a Raman active gas means that the power required for generating stimulated Raman scattering (SRS) is much lowered. HCPCF has a light transmission length scale of the order of kilometers. In such a fibre, the light is confined and guided in a narrow bore (˜10 μm diameter) exclusively by the surrounding photonic structure made up of a periodic array of air holes in glass. The photonic crystal cladding acts as an “out-of-plane” photonic bandgap enabling light guidance with extremely low loss over a certain bandwidth (˜70 THz) whose spectral location can be tailored at wish. Such a fibre has the ability to guide light through air or a chosen gas-phase material rather than glass. When the hollow core of the fibre is filled with an active gas, it offers an unprecedented length where a laser field can interact with a gas phase material in a diffractionless fashion, thus contrasting with the intrinsic diffractive nature of free space laser beams. As a result, this lowers, for example, the power required for generating rotational SRS in hydrogen by a factor of more than one million (for example, only a few Watts of pump peak power being required if ˜30 m long fibre is used) whilst exhibiting a near quantum-limited conversion and quantum effects such as electromagnetically induced transparency (EIT) are made possible in molecular gases. Consequently, using a HCPCF 203 filled with a Raman active gas, CW pump power of only of the order of 10 W is sufficient for the generation of efficient Raman sidebands 204. Fibre properties such as the transmission bandwidth location and the fibre transmission may be tailored by optimizing the fibre-core shape and the dispersion management, to the desired application.

The CW laser source 200 comprises a CW laser 400, discussed below in relation to FIG. 4. In order to generate Raman sidebands, the driving lasers 201, 202 have to have a narrow linewidth in order to minimize the dephasing rate and hence maximizing the established coherence. This requirement is possible by using a powerful (up to several 100 W) CW fibre laser 400 operable at the single-frequency regime. Such fibres are commercially available (for example YLR-100-1064-SF from IPG co.) delivering a laser beam with 100 W and a linewidth of only a few KHz. The combination of a low-loss HCPCF 203 with a powerful single-frequency laser 400 means that molecular modulation can be achieved with CW driving fields.

In addition to the advantages of the example optical waveform generator being described, there are various other technical advantages of the use of narrow-linewidth CW pumps 201, 202 for Raman sidebands generation over that of pulsed pumps. Indeed with pulsed driving lasers, the requirement for a strong adiabaticity conflicts with that of a strong coherence leading to a trade-off in the tolerable values of the two-photon Rabi frequency. This compromise is lifted when using CW lasers as the system operates in the steady-state regime. Moreover, the relatively low powers required thanks to the use of HCPCF mean that the Stark effect is minimized and hence strong coherence can be achieved even with small detuning (subMHz). In short, the use of CW pumps 201, 202 make the technical implementation easier and the result more efficient.

An example two-pump laser source 200 is shown in FIG. 4. The laser source 200 comprises a CW laser 400 with a first port 401 and a second port 402. The output of the laser source 200 consists of two beams 404, 405. A first pump 404 (201 in FIG. 2) operating at a frequency ωₚ is extracted from the laser 400 though the first port 401. The laser 400 is arranged to excite a second HCPCF 403 filled with a Raman active gas through the second port 402. This may be the same gas or a different gas to that filling the first HCPCF 203. This generates a second pump 405 (202 in FIG. 2) which is a Stokes beam generated via SRS in the second HCPCF 403 filled with Raman active gas. The HCPCF 403 is kept under controllable temperature T₀ and pressure P₀. The operating frequency ω_{S}=ω_{P}−Ω(T₀,P₀) of the second pump 405 is then tunable via temperature and pressure. The two pumps 404, 405; 201, 202 act as the driving fields for the Raman sideband generation described in relation to FIG. 2.

The temperature and pressure may be chosen in order to have adequate efficiency conversion but also kept in a range so that the linewidth of the generated second pump 405 remains narrow enough for the coherence requirements. The pressure and fibre length may optimized for a near-to quantum limited single frequency conversion to the Stokes. With a narrow-linewidth CW laser with 10 W output power, it is possible to generate the desired Stokes (rotational transition from either orthohydrogen (˜18 THz shift) or parahydrogen (˜10 THz)) efficiently (near quantum limited conversion), even with current fibre transmission performances in the region of 60-70 dB/km at 1064 nm. A higher performance HCPCF makes this possible even with lower pump powers.

The optical waveform generator described above has a spectrum limited by the transmission bandwidth of the HCPCF which is typically around 70 THz. Consequently, the shortest pulses achievable are about a few femtoseconds (assuming a time-bandwidth product ˜0.4). Going below the “femtosecond barrier” to attosecond pulses necessitates larger spectral bandwidth. The necessary additional bandwidth could be obtained by using a HCPCF with a much larger transmission spectrum whilst keeping the loss ultra-low (less than 60 dB/km) using appropriate bandgap fibres. A single hollow core fibre may be used provided that the fibre bandwidth is much wider than the 70 THz bandwidth of the fibre discussed above and the loss kept to a level such that the pumping can be achieved with CW lasers.

Alternatively, the present approach can be enhanced to enable the enlargement of the Raman sidebands spectrum by up to two octaves by only using current state-of-the-art HCPCF fabrication. This relies on the use of a series of ˜70 THz wide HCPCFs with a different bandwidth location aligned in an arborescence-like arrangement. The basic building block of this arborescence is shown in FIG. 5 and consists of three HCPCF based RSBGs (HCPCF-RSBGs). The first HCPCF-RSBG (“a stem fibre”) is the first-level RSBG described above with reference to FIG. 2 and analogously comprises a two-pump CW laser source 500 which generates two pumps 501, 502 arranged to excite a second HCPCF 503 to generate a Raman sideband spectrum 504. The second HCPCF 503 has a transmission band tailored to be centred substantially midway between the frequencies of the first 501 and second 502 pumps.

Two spectral components 505, preferably being the two most blue-shifted spectral components, of the first generated Raman sideband spectrum are extracted and used as driving fields (pumps) of a second-level RSBG (“a branch fibre”). The second-level RSBG comprises these two pumps 505 and a third HCPCF 506 filled with the Raman active gas. The pressure and temperature of the gas filling each HCPCF-RSBG are set at the appropriate values in order to ensure the strong coherence requirement.

The transmission band of the third HCPCF 506 is shifted to higher frequencies such that the new driving field frequencies lie within the transmission spectrum. As a result, a Raman sideband spectrum 507 is generated which is shifted (>+30 THz) with respect to the first spectrum 504. The spectral components of this spectrum 507 are phase-coherent with the driving fields 505 and consequently they are also phase-coherent with all the components of the first Raman sideband spectrum 504. This means that the combination of the two spectra forms a coherent spectrum.

Similarly, a further pair 508 of spectral components of the first Raman sideband spectrum 505, preferably being the two most red-shifted spectral components, may be used to excite another second-level RSBG through a fourth HCPCF 509 with a transmission band which is red-shifted relative to that of the stem fibre 503. The generated Raman sideband spectrum 510 is consequently red-shifted relative to the first spectrum 504 by ˜30-40 THz. The two shifted spectra 507, 510 are then combined with the spectrum 506 to form a coherent radiation but with almost double the initial bandwidth.

Such an arborescence may be extended by adding higher-level RSBGs (more branch fibres) to enlarge the overall coherent spectrum to the desired bandwidth. The coherent features of an exceedingly low phase noise and exceedingly high accuracy oscillation are transferred via a sequence of harmonic generation which ensures a “phase-traceability” at each step of the chain. This means that all the generated harmonics are mutually coherent. The “phase-trace” of the initial Raman sideband spectrum 504 is “transferred” to the second spectrum 507, 510, preferably via the most blue or red shifted fields which, in addition to being driving fields generating different sidebands, play the role of “phase-trace” carriers encrypted during the generation of the first spectrum 504. This enables the combination of the different spectra 504, 507, 510 to form a coherent radiation and consequently a synthesizable temporal waveform.

With current state-of-the-art fibre fabrication technology it is possible to generate a spectrum spanning from ˜300 nm in the UV (which is still away from the first electronic transition of the hydrogen), to ˜2000 nm in the IR. Furthermore, with a CW fibre laser operating at 1064 nm, such as an Ytterbium doped fibre, it would require an arborescence containing 5 to 6 different low-loss HCPCFs and less than 100 W of initial power for the generation of such ultra-broad spectrum.

It is possible to make an all-fibre version using current all-fibre gas cell and laser technology and all fibre versions of all the necessary optical components for dispersion compensation, power attenuation and wavelength demultiplexing. This gives a compactness and integrability which is very useful for technological implementations. Using HCPCF filled with a Raman active gas, CW pump power of only of the order of 10 W is sufficient for the generation of efficient Raman sidebands and may be done in an all fibre system.

The HCPCF may be any commercially available HCPCF and the two-pump CW laser source may comprise any commercially available CW laser. Pressure and temperature control may be accomplished by conventional means.

The applications of the proposed system are far reaching and cover both technology and science. There are many fields which may benefit from the availability of the optical waveform generator.

Ultra-short pulses are an ideal tool for triggering and monitoring sequences of very rapid chemical and biological processes. This has led to an area of physical chemistry, called “femtochemistry”. Sub-femtosecond pulses generated by the optical waveform generator may be used in such monitoring, making it possible to obtain slow-motion film of even faster chemical processes and to reveal more biological processes which can be of great importance in medicine or pharmacy.

Since the time scale of a Bohr orbit of ground-state hydrogen is ˜152 attosecond, it is expected that sub-femtosecond pulses can accurately probe the transient absorption and fluorescence and other electronic processes. By the very nature of the generation process, the light source of the optical waveform generator produces ultra-fast oscillating waveforms, which are perfectly synchronized with the molecular motion in the given molecular system and provide a unique tool for studying molecular and electronic dynamics. It is possible to use the coherent molecular motion to control multi-photon excitations in an EIT-like manner: there may be destructive or constructive interference among different multiphoton paths depending on the relative phase of the molecular motion and the Raman sidebands. Possible extensions of this general technique range from studying complicated multi-mode motion of complex molecules, to probing ultrafast electronic dynamics in atoms.

The optical waveform generator provides a grid of coherent CW laser sources spanning an extremely large spectrum, and covers some wavelengths which are inaccessible using semiconductor and solid-state lasers. Such mutually coherent, correlated laser sources may be used in fields such as quantum telecommunication and “teleportation”, surgery and biomedicine.

The optical waveform generator may be configured to act as AM and FM modulator at the speed of THz, in high bandwidth optical processing which is often restricted by the achievable bandwidth of electronic processors (electronic bottleneck). The coherence and the ultra-fast modulation of the proposed system would be beneficial in encoding and decoding information on an optical fibre communications link.

Knowing more about fast relaxation processes of hot carriers in semiconductors and nanotechnology devices such as the interaction of excitons and phonons has prompted intensive studies of semiconductors of practical importance. Indeed, work in semiconductors is already showing signs of potentially immediate industrial applications, particularly for testing the fastest components, i.e., those capable of switching in a time of 10 picoseconds or less. Work has commenced on an optical logic which will ultimately permit development of computers much faster than the electronic type in different laboratories in the world. By using two light ultra-short pulses of different colours and modulated light at optical frequencies, a device which can switch in a few hundredths of a femtosecond (1000 times faster than the electronic components presently used in computers) is developed.

Other areas which could benefit from the optical wave generator are: nonlinear optics; precise frequency and length metrology, wavelength conversion; laser tweezers; THz waves; optical telecommunications; fibre sensing; UV and x-ray generation and guidance; fibre fabrication; quantum sources; laser manufacturing; spectroscopy; fluorescence detection and microscopy; photonic device test and evaluation; new light source technology; fluid mechanics; cold atoms and Bose-Einstein condensates; biomedical sensing; applied mathematics; (bio)chemistry and astronomical imaging.

1. An optical wave generator comprising a Raman sideband generator (RSBG), the RSBG comprising:
a first hollow-core photonic crystal fibre (HCPCF) arranged to be filled with a first Raman active gas; and
a first two-pump continuous wave (CW) laser source having a first pump laser beam at a first frequency and a second pump laser beam at a second frequency, the laser source being arranged to excite the first gas to be contained in the first HCPCF to generate a Raman sideband spectrum comprising a first plurality of spectral components.

2. An optical wave generator according to claim 1, wherein the first and second frequencies are arranged to have a difference which is slightly detuned from a Raman transition of the first gas to be contained in the first HCPCF.

3. An optical wave generator according to claim 1, further comprising a first temperature controller arranged to maintain the first HCPCF at a first temperature.

4. An optical wave generator according to claim 1, further comprising a first pressure controller arranged to maintain the first HCPCF at a first pressure.

5. An optical wave generator according to claim 1, wherein the first HCPCF is filled with a first Raman active gas.

6. An optical wave generator according to claim 1, further comprising a first frequency controller arranged to control a frequency of the second pump.

7. An optical wave generator according to claim 1, wherein the first laser source comprises:
a CW laser having a first port and a second port, wherein the laser is arranged to generate the first pump through the first port; and
a second HCPCF arranged to be filled with a second Raman active gas;
wherein the laser is arranged to excite the second gas to be contained in the HCPCF through the second port to generate the second pump.

8. An optical wave generator according claim 7, further comprising a first frequency controller arranged to control a frequency of the second pump wherein the first frequency controller is arranged to control the second frequency by maintaining the second HCPCF at least one of a second temperature and a second pressure.

9. An optical wave generator according to claim 1, wherein the first HCPCF is arranged to have a transmission frequency band centred substantially midway between the first frequency and the second frequency.

10. An optical wave generator according to claim 7, wherein the second HCPCF is filled with a second Raman active gas.

11. An optical wave generator according to claim 7, further comprising a second RSBG stage, the second RSBG stage comprising at least one RSBG component having:
a third HCPCF arranged to be filled with a third Raman active gas; and
a second two-pump CW laser source comprising a third pump and a fourth pump, wherein the third and fourth pumps comprise two of the first plurality of spectral components;
wherein the second laser source is arranged to excite the third gas to be contained in the third HCPCF to output a Raman sideband spectrum comprising a second plurality of spectral components.

12. An optical wave generator according to claim 11, wherein the second RSBG stage comprises two RSBG components, the third and fourth pumps of one of the RSBG components comprising the two most blue-shifted spectral components of the first plurality of spectral components and the third and fourth pumps of the other RSBG component comprising the two most red-shifted spectral components of the first plurality of spectral components.

13. An optical wave generator according to claim 11, wherein the third HCPCF is filled with a third Raman active gas.

14. An optical wave generator according to claim 11, further comprising at least one further RSBG stage, each further RSBG stage comprising at least one further RSBG component, each at least one further RSBG component having:
a further HCPCF arranged to be filled with a further Raman active gas; and
a further two-pump CW laser source comprising a further pair of pumps, wherein the further pair of pumps comprises two of the plurality of spectral components from the RSBG of the previous stage;
wherein the further laser source is arranged to excite the further gas to be contained in the further HCPCF to output a Raman sideband spectrum comprising a further plurality of spectral components.

15. An optical wave generator according to claim 14, wherein each further RSBG stage comprises two further RSBG components, the further pumps of one of the higher-level RSBGs comprising the two most blue-shifted spectral components of the plurality of spectral components from the previous RSBG stage and the further pumps of the other of the higher-level RSBGs comprising the two most red-shifted spectral components of the plurality of spectral components from the previous RSBG stage.

16. An optical wave generator according to claim 14, wherein the RSBG, second RSBG stage and at least one further RSBG stage are arranged in an arborescent manner.

17. An optical wave generator according to claim 14, wherein the further HCPCF is filled with a further Raman active gas.

18. An optical wave generator according to claim 14, wherein the first, second, third and further gases are each one of H₂, D₂, SF₆, Rb, Cs, Ca and Na.

19. An optical wave generator according to claim 11, wherein each RSBG is made from HCPCF.

20. An optical wave generator according to claim 1, further comprising an output component arranged to output a generated waveform.

21. An optical wave generator according to claim 20, wherein the output component comprises an autocorrelator or a frequency resolved optical grating.

22. An optical waveform synthesizer comprising an optical wave generator according to claim 1.

23. A coherent laser source comprising an optical wave generator according to claim 1.

24. An attosecond pulse generator comprising an optical wave generator according to claim 1.

25. An optical switcher comprising an optical wave generator according to claim 1.

26. A TeraHertz coherent radiation source comprising an optical wave generator according to claim 1.

27. A method of generating an optical wave comprising the step of:
exciting a first hollow-core photonic crystal fibre (HCPCF) filled with a first Raman active gas with first and second pump laser beams of a first two-pump continuous wave (CW) laser source to generate a Raman sideband spectrum comprising a first plurality of spectral components.

28. A method according to claim 27, further comprising the steps of:
generating the first pump through a first port of a CW laser; and
exciting a second HCPCF filled with a second Raman active gas through a second port of the CW laser to generate the second pump.

29. A method according to claim 27, further comprising the step of:
exciting a third HCPCF filled with a third Raman active gas with two of the first plurality of spectral components to generate a second Raman sideband spectrum comprising a first plurality of spectral components.

30. A method according to claim 29, wherein the two of the first plurality of spectral components are the two most blue-shifted spectral components.

31. A method according to claim 29, wherein the two of the first plurality of spectral components are the two most red-shifted spectral components.

32. (canceled)
